(19) United States
(12) Patent Application Publication
(10) Pub. No.: US 2014/0237821 A1
(43) Pub. Date: Aug. 28, 2014

(54) TURBOMACHINE BLADE PRODUCTION METHOD

(71) Applicant: PIETRO ROSA T.B.M. S.r.I., Maniago (IT)

(72) Inventor: Andrea Maurizio, Cavasso Nuovo (IT)

(21) Appl. No.: 14/194,373

(22) Filed: Feb. 28, 2014

(30) Foreign Application Priority Data
Feb. 28, 2013 (IT) TV2013A000030

(51) Int. Cl. B23P 15/04

(52) U.S. Cl. CPC B23P 15/04
USPC 29/889.71

(57) ABSTRACT

A method of producing a turbomachine blade having a coupling root, and an airfoil-shaped oblong member cantilevered from the coupling root; the airfoil-shaped oblong member having a main plate-like element connected directly to the coupling root, and a cover plate for sealing a hollow weight-reducing seat formed in one of the two major faces of the main plate-like element; the main plate-like element being divided into a lower connecting fin cantilevered from the coupling root, and a plate-like body butt welded to the lower connecting fin to form an extension of the lower connecting fin; the method being characterized by including the steps of twisting and curving a flat plate of constant thickness greater than the maximum thickness of the plate-like body of the blade, to obtain a blank plate, in which the three-dimensional shape of the centerline surface of the blank plate substantially matches the three-dimensional shape of the centerline surface of the plate-like body of the main plate-like element.

### BACKGROUND

1. Technical Field

The present disclosure relates to a turbomachine blade production method.

More specifically, the present disclosure relates to a method of producing a lightweight rotor or stator blade for a compressor or front fan of an aircraft turbine engine, to which use the following description refers purely by way of example.

2. Description of the Related Art

As is known, rotor and stator blades of aircraft turbine engine compressors substantially comprise a coupling root designed to fit and lock rigidly to the compressor hub or center blade mounting disk; and an airfoil-shaped oblong member, which cantilevers from the coupling root, so as to cantilever radially outwards of the blade mounting hub or disk when the coupling root is fixed inside the hub or center blade mounting disk.

Stator blades also have an upper coupling head, which is located at the top end of the airfoil-shaped oblong member, i.e. at the opposite end to the coupling root, and is designed to fit and lock rigidly to the outer blade mounting ring of the compressor.

Having to withstand fairly severe mechanical stress and heat, the lower coupling root, the airfoil-shaped oblong member, and the upper coupling head (if there is one) are usually formed in one piece from a single block of high-strength metal, which is forged and then milled to shape the blade as required.

To reduce inertia and the overall weight of turbine engines, some aircraft turbine engine manufacturers have opted over the past few years to employ blades with hollow airfoil-shaped oblong members in parts of the engine, so as to drastically reduce the amount of metal needed to make the blade.

Patent Application US2006/039792 describes a method of producing a lightweight aircraft turbine engine blade, which comprises:
milling, roughly in the middle of one of the two major faces of the airfoil-shaped oblong member, a large hollow seat substantially reproducing, to a smaller scale, the shape of the airfoil-shaped oblong member itself;
sealing the opening of the hollow seat with a cover plate perfectly complementary in shape to the seat opening; and
welding the peripheral edge of the cover plate to the mating edge in the airfoil-shaped oblong member.

Producing a lightweight blade from a single block of metal, however, is an extremely painstaking, time-consuming, high-cost job, because of the large amount of material the numeric-control milling machine has to remove to shape the part as required.

### BRIEF SUMMARY

It is therefore an object of the present disclosure to provide a method of producing a lightweight turbomachine blade, designed to significantly reduce the manufacturing cost of blades of this sort.

According to the present disclosure, there is provided a method of producing a turbomachine blade, as defined in claim 1 and preferably, though not necessarily, in any one of the claims dependent on claim 1.

### BRIEF DESCRIPTION OF THE SEVERAL VIEWS OF THE DRAWINGS

A non-limiting embodiment of the present disclosure will be described by way of example with reference to the attached drawings, in which:

FIG. 1 shows a partly exploded view in perspective of a lightweight turbomachine blade in accordance with the teachings of the present disclosure;

FIG. 2 shows a section of the FIG. 1 blade along line A-A:

FIGS. 3 to 11 show schematics of steps in the method of producing the lightweight turbomachine blade in FIGS. 1 and 2;

FIG. 12 shows a view in perspective of a further embodiment of the lightweight turbomachine blade in FIG. 1.

### DETAILED DESCRIPTION

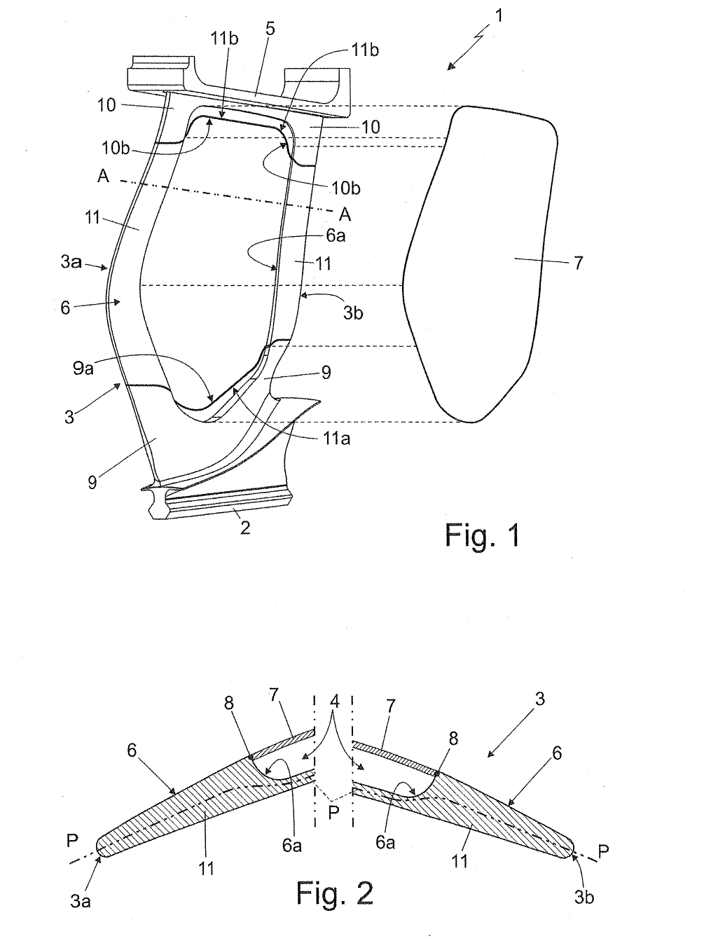

With reference to FIGS. 1 and 2, number 1 indicates as a whole a lightweight turbomachine blade, which may be used to advantage, for example, in the compressor or front fan of a preferably, though not necessarily, aircraft turbine engine.

Lightweight blade 1 is made of metal, and substantially comprises a lower coupling root 2 designed to fit and lock rigidly to the turbine engine hub or center blade mounting disk (not shown); an airfoil-shaped oblong member 3 which cantilevers from coupling root 2, so as to cantilever substantially radially outwards of the hub or blade mounting disk (not shown) when coupling root 2 is fixed inside the hub or center blade mounting disk, and inside has a large closed weight-reducing cavity 4, the three-dimensional shape of which preferably, though not necessarily, substantially reproduces, to a smaller scale, the three-dimensional shape of airfoil-shaped oblong member 3 as a whole; and an upper coupling head 5, which is located at the second end of airfoil-shaped oblong member 3, i.e. at the opposite end to coupling root 2, and is designed to fit and lock rigidly to the turbine engine outer blade mounting ring (not shown).

In other words, airfoil-shaped oblong member 3 is designed to joint/connect coupling root 2 rigidly to coupling head 5.

In the example shown, in particular, coupling root 2, airfoil-shaped oblong member 3, and coupling head 5 are preferably, though not necessarily, made of titanium alloy, aluminum alloy, or special high-strength steel.

Airfoil-shaped oblong member 3, in turn, comprises a substantially airfoil-shaped, main plate-like element 6 which connects directly to coupling root 2 and coupling head 5, and which, substantially in the center of one of its two major faces, has at least one hollow weight-reducing seat 6a of predetermined shape; and a cover plate 7 which closes the opening of hollow seat 6a to form the inner cavity 4 and complete the outer profile of airfoil-shaped oblong member 3.

More specifically, hollow weight-reducing seat 6a preferably extends over more than 40% of the total area of the major face of main plate-like element 6 in which hollow seat 6a is formed.

Preferably cover plate 7 instead is complementary in shape to, and serves to airtight seal, the opening of hollow seat 6a.

More specifically, cover plate 7 is preferably fixed irremovably to the opening of hollow seat 6a in main plate-like element 6 by a weld bead 8 preferably extending seamlessly along the whole peripheral edge of cover plate 7.

Preferably, though not necessarily, the shape of hollow seat 6a also roughly reproduces, to a smaller scale, the three-dimensional shape of airfoil-shaped oblong member 3 as a whole.

With reference to FIGS. 1 and 2, main plate-like element 6 in turn is divided into a lower connecting fin 9, which cantilevers from coupling root 2 towards coupling head 5 and is formed in one piece with coupling root 2; an upper connecting fin 10, which cantilevers from coupling head 5 towards coupling root 2 and is formed in one piece with coupling head 5; and a center plate-like body 11, which is located between the two connecting fins 9 and 10, is shaped/designed to form an extension of connecting fins 9 and 10, and is butt-welded to, to form one piece with, connecting fins 9 and 10. Center plate-like body 11 is also shaped to at least partly bound/form hollow seat 6a of main plate-like element 6.

More specifically, the lower edge 11a of center plate-like body 11 and the ridge 9a of lower connecting fin 9 are complementary in shape, and are butt welded to each other so that center plate-like body 11 forms one piece with lower connecting fin 9; and the upper edge 11b of center plate-like body 11 and the ridge 10b of upper connecting fin 10 are complementary in shape, and are butt welded to each other so that center plate-like body 11 forms one piece with upper connecting fin 10.

More specifically, lower edge 11a of center plate-like body 11 and ridge 9a of lower connecting fin 9 preferably extend from the leading edge 3a to the trailing edge 3b of airfoil-shaped oblong member 3 along a curved, preferably, though not necessarily, substantially Ω (omega) shaped path.

Likewise, upper edge 11b of center plate-like body 11 and ridge 10b of upper connecting fin 10 preferably also extend from the leading edge 3a to the trailing edge 3b of airfoil-shaped oblong member 3 along a curved, preferably, though not necessarily, substantially Ω (omega) shaped path.

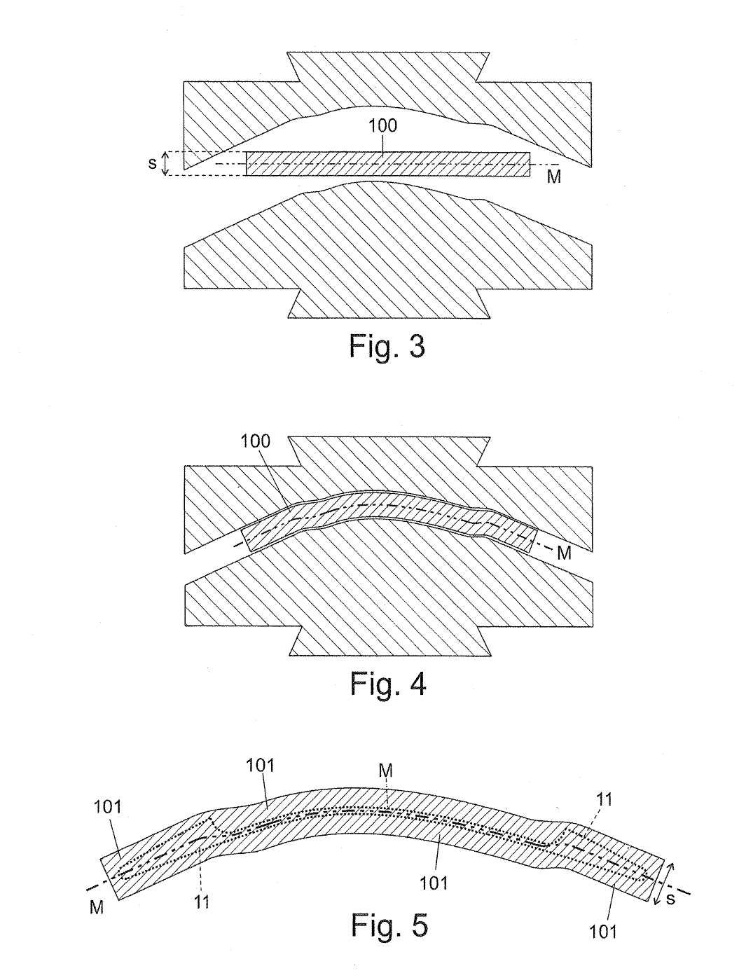

With reference to FIGS. 3, 4 and 5, the method of producing lightweight blade 1 comprises:
making a flat metal plate 100 of substantially constant thickness s greater than the maximum thickness of center plate-like body 11 of blade 1, and with a contour over-approximating the flat, spread-out contour of center plate-like body 11; and
twisting and curving flat plate 100 by means of a sheet metal forming process (i.e. press-forming with no appreciable reduction in the nominal thickness of the plate) to obtain a blank plate 101, in which the three-dimensional shape of the centerline surface M of the press-formed plate 101 substantially matches that of the centerline surface P of center plate-like body 11 of airfoil-shaped oblong member 3 of blade 1.

As used herein, “over-approximates” and “over-approximating” refer to approximating with a larger value or size.

In other words, the method of producing lightweight blade 1 comprises twisting and curving a flat plate 100 by means of a forming process (i.e. plastic deformation of the plate, with no appreciable reduction in its nominal thickness) so that the centerline surface M of the resulting blank plate 101 substantially matches the centerline surface P of the designed center plate-like body 11.

Where the ‘centerline surface’ is the locus/set of points inside the center plate-like body, which are locally equidistant from the surfaces forming the two major faces of the center plate-like body.

The centerline surface M of blank plate 101 is therefore the curved surface formed by the points locally equidistant from the two faces of blank plate 101. And the centerline surface P of center plate-like body 11 is the curved surface formed by the points locally equidistant from the surfaces of the two faces of center plate-like body 11, also taking into account the depression formed by the portion of hollow weight-reducing seat 6a in center plate-like body 11.

In other words, the three-dimensional shape of centerline surface P of center plate-like body 11 is also determined by the shape of the portion of hollow weight-reducing seat 6a formed in center plate-like body 11.

In the example shown, thickness s of flat plate 100 preferably over-approximates the maximum thickness of center plate-like body 11 of blade 1.

More specifically, the difference between the thickness s of flat metal plate 100 and the maximum thickness of center plate-like body 11 must preferably be less than 2 mm (millimeters).

Preferably, though not necessarily, the thickness s of flat plate 100 ranges between 5 mm and 40 mm (millimeters).

In the example shown, flat metal plate 100 of constant thickness over-approximating the maximum thickness of center plate-like body 11 is preferably obtained by appropriately cutting a large flat metal plate (not shown) of constant thickness greater than the maximum thickness of the center plate-like body 11 of the airfoil-shaped oblong member 3 of the to-be-made blade 1.

In other words, the method of producing blade 1 comprises cutting, from a large flat metal plate (not shown) of constant thickness over-approximating the maximum thickness of center plate-like body 11, a plate portion with a contour over-approximating the contour, flat spread-out on the laying plane, of the center plate-like body 11 of the airfoil-shaped oblong member 3 of the blade 1 to be made, thus to obtain the flat plate 100.

In the example shown, the thickness of the flat metal plate preferably over-approximates the maximum thickness of center plate-like body 11 of blade 1, and preferably ranges between 5 mm and 40 mm (millimeters).

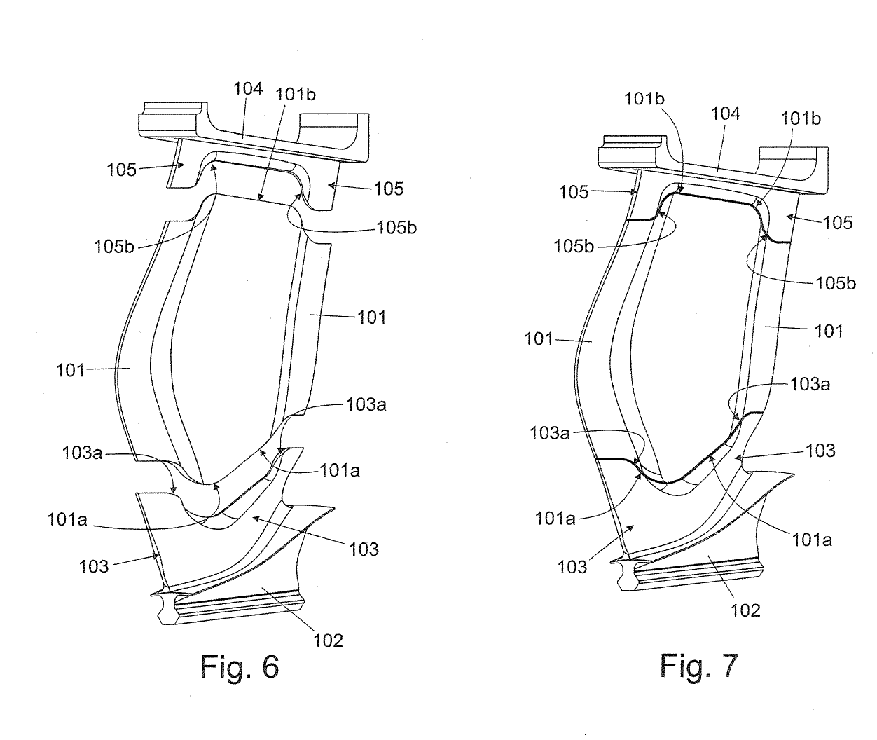

With reference to FIGS. 6 and 7, the method of producing blade 1 also comprises:
making, preferably by milling and/or stamping and/or forging and/or die-casting, a first semifinished metal part 102, the three-dimensional shape of which over-approximates the shape of coupling root 2 of blade 1, and which also has a projecting appendage 103, the three-dimensional shape of which over-approximates the shape of lower connecting fin 9.

With reference to FIGS. 6 and 7, the method of producing blade 1 then comprises:
shaping the lower edge 101a of blank plate 101 and the ridge 103a of projecting appendage 103 of semifinished part 102, so that the lower edge 101a of blank plate 101 and the ridge 103a of projecting appendage 103 are complementary in shape;
placing the lower edge 101a of blank plate 101 on the ridge 103a of projecting appendage 103, so that blank plate 101 is aligned locally with projecting appendage 103; and
butt-welding the lower edge 101a of blank plate 101 to ridge 103a of projecting appendage 103 to connect the two parts rigidly to each other.

More specifically, in the example shown, the method of producing blade 1 preferably comprises shaping the lower edge 101a of blank plate 101 and the ridge 103a of projecting appendage 103, so that they extend from the leading edge 3a to the trailing edge 3b of airfoil-shaped oblong member 3 along a curved, preferably, though not necessarily, substantially Ω (omega) shaped path.

With reference to FIGS. 6 and 7, the method of producing blade 1 also comprises:
making, preferably by milling and/or stamping and/or forging and/or die-casting, a second semifinished metal part 104, the three-dimensional shape of which over-approximates the shape of coupling head 5 of blade 1, and which also has a projecting appendage 105, the three-dimensional shape of which over-approximates the shape of upper connecting fin 10.

With reference to FIGS. 6 and 7, the method of producing blade 1 then comprises:
shaping the upper edge 101b of blank plate 101 and the ridge 105b of projecting appendage 105 of semifinished part 104, so that the upper edge 101b of blank plate 101 and the ridge 105b of projecting appendage 105 are complementary in shape;
placing the upper edge 101b of blank plate 101 on the ridge 105b of projecting appendage 105, so that blank plate 101 is aligned locally with projecting appendage 105; and
butt-welding the upper edge 101b of blank plate 101 to ridge 105b of projecting appendage 105 to connect the two parts rigidly to each other.

More specifically, in the example shown, the method of producing blade 1 preferably comprises shaping the upper edge 101b of blank plate 101 and the ridge 105b of projecting appendage 105, so that they extend from the leading edge 3a to the trailing edge 3b of airfoil-shaped oblong member 3 along a curved, preferably, though not necessarily, substantially Ω (omega) shaped path.

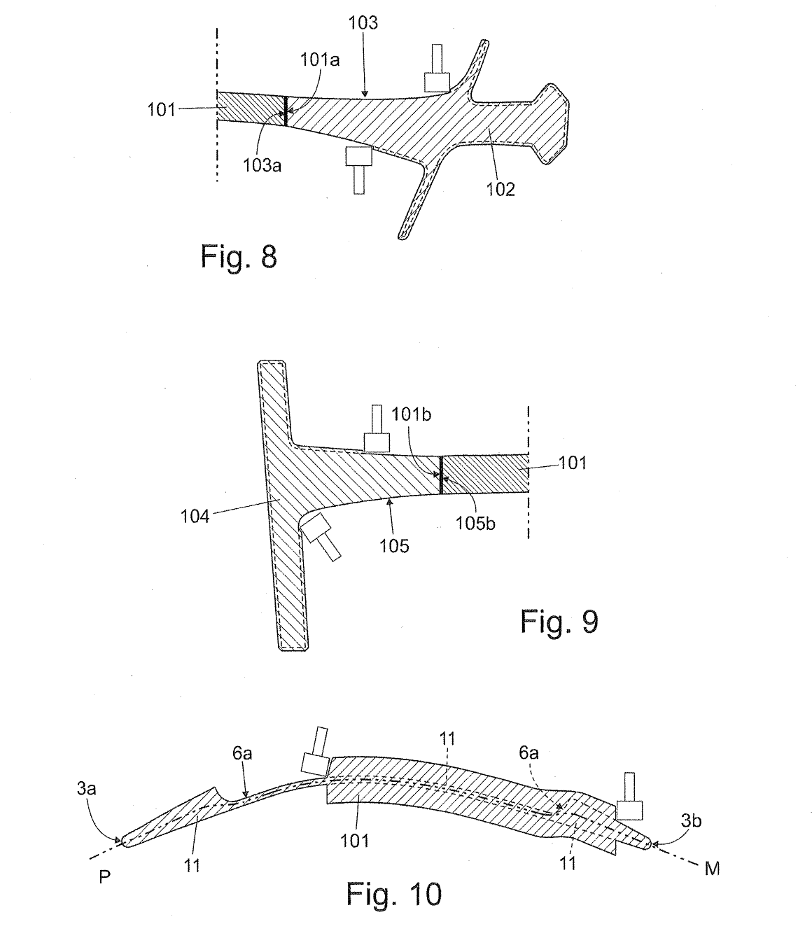

With reference to FIGS. 8, 9 and 10, after welding lower edge 101a of blank plate 101 to ridge 103a of projecting appendage 103, and upper edge 101b of blank plate 101 to ridge 105b of projecting appendage 105, the method of producing blade 1 comprises trimming/machining, by milling or other material-removing machining operation, the excess material from the resulting part to obtain coupling root 2, main plate-like element 6 of airfoil-shaped oblong member 3, and coupling head 5 of blade 1 of the desired shape.

More specifically, during the step of removing excess material from the part formed by butt-welding blank plate 101 to the two semifinished parts 102 and 104, the method of producing blade 1 comprises:
trimming/machining, by milling or other material-removing machining operation, excess metal off the two semifinished parts 102 and 104, to obtain coupling root 2 and coupling head 5 respectively of lightweight blade 1; and/or
trimming/machining, by milling or other material-removing machining operation, excess metal off the long side edges of blank plate 101 and the two projecting appendages 103 and 105, so as to form leading edge 3a and trailing edge 3b of airfoil-shaped oblong member 3; and/or
trimming/machining, by milling or other material-removing machining operation, excess metal off the two major faces of blank plate 101 and the two major faces of projecting appendages 103 and 105, to obtain main plate-like element 6 of airfoil-shaped oblong member 3, together with hollow weight-reducing seat 6a.

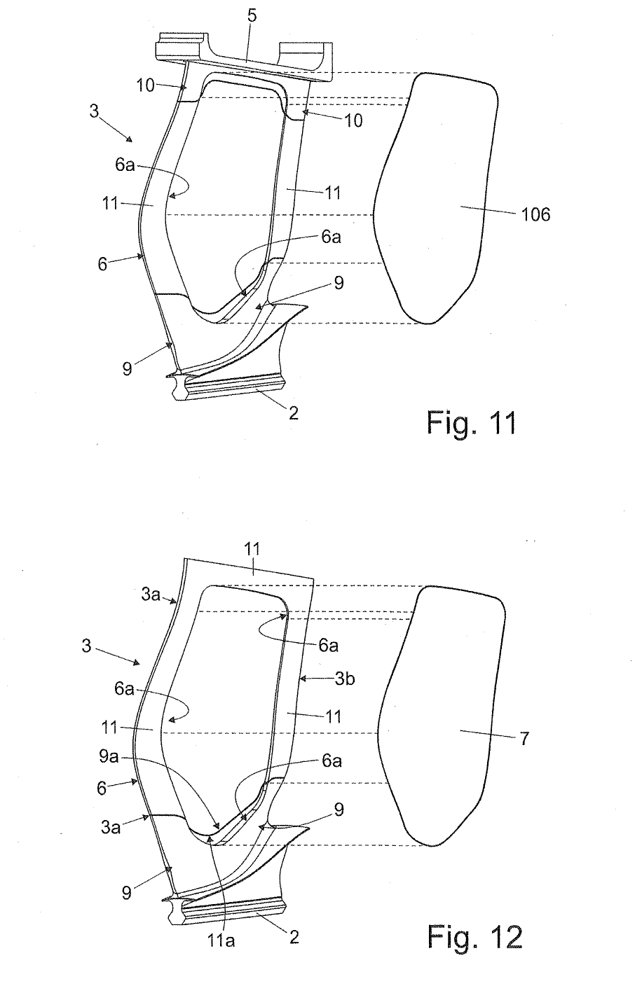

With reference to FIG. 11, after removing excess material from the part formed by butt welding blank plate 101 to the two semifinished parts 102 and 104, the method of producing blade 1 comprises closing, preferably sealing, the opening of hollow seat 6a in one of the two faces of main plate-like element 6 by means of a further plate-like element 106 of predetermined thickness, so as to complete the outer profile of airfoil-shaped oblong member 3 and at the same time form the inner cavity 4 in airfoil-shaped oblong member 3.

More specifically, in the example shown, the method of producing blade 1 preferably comprises:
making a further plate-like element 106, the three-dimensional shape of which is complementary to that of the opening of the hollow seat 6a in the face of main plate-like element 6, and the thickness of which is less than the depth of hollow seat 6a;
placing plate-like element 106 on the face of main plate-like element 6 in which hollow seat 6a is formed, so as to seal the opening of hollow seat 6a; and
fixing plate-like element 106 irremovably to main plate-like element 6.

Plate-like element 106 thus forms the cover plate 7 of the airfoil-shaped oblong member.

In the example shown, the method of producing blade 1 comprises preferably fixing plate-like element 106 irremovably to main plate-like element 6 by means of a weld bead preferably extending seamlessly along the entire peripheral edge of plate-like element 106; and then trimming/machining, by milling or other material-removing machining operation, excess metal off the weld between plate-like element 106 and main plate-like element 6.

In the example shown, the method of producing lightweight blade 1 preferably provides to obtain plate-like element 106 by cutting, from a large flat, preferably 1-4 mm (millimeter) thick metal sheet (not shown), a plate portion complementary in shape to the contour of the opening of hollow seat 6a.

The method of producing blade 1 as described has numerous advantages.

Firstly, making center plate-like body 11 of main plate-like element 6 by sheet metal forming the flat plate 100, i.e. by press-forming flat plate 100 with no appreciable reduction in the nominal thickness of the plate, greatly reduces the manufacturing cost of blade 1. Which cost saving is considerable in the case of large-size blades 1.

Sheet metal forming of a flat plate, in fact, is a processing technique which is different from forging, which produces a plastic deformation of the plate with no appreciable reduction in its nominal thickness, and which requires much less energy, with all the economic advantages this entails.

Secondly, twisting and curving flat plate 100 to form a blank plate 101 in which the three-dimensional shape of centerline surface M of the plate substantially matches the three-dimensional shape of the centerline surface P of center plate-like body 11, minimizes the amount of metal that has to be milled or otherwise machined off to obtain center plate-like body 11.

Last but not least, the method of producing blade 1 allows the semifinished parts 102 and 104, eventually forming coupling root 2 and coupling head 5 of blade 1, to be produced separately using production processes best suited to the three-dimensional shape and desired mechanical characteristics of each part.

Clearly, changes may be made to blade 1 and to the method of producing it, without, however, departing from the scope of the present disclosure.

For example, with reference to FIG. 12, blade 1 may have no coupling head 5. In which case, main plate-like element 6 of airfoil-shaped oblong member 3 is made up of the lower connecting fin 9 which cantilevers from, and is formed in one piece with, the coupling root 2; and of center plate-like body 11 which only forms an extension of lower connecting fin 9, and is butt-welded to, to form one piece with, lower connecting fin 9.

1. A method of producing a turbomachine blade comprising a coupling root, and an airfoil-shaped oblong member cantilevered from said coupling root; said airfoil-shaped oblong member comprising a main plate-like element connected directly to the coupling root, and a cover plate for closing a hollow weight-reducing seat formed in one of two faces of said main plate-like element; said main plate-like element including a lower connecting fin cantilevered from the coupling root, and a plate-like body butt welded to said lower connecting fin to form an extension of the lower connecting fin; the method comprising:
making a flat metal plate of substantially constant thickness greater than a maximum thickness of the plate-like body of the blade, and with a contour over-approximating a flat, spread-out contour of said plate-like body; and
twisting and curving said flat metal plate using a sheet metal forming process, thus to obtain a blank plate having a centerline surface with a three-dimensional shape that substantially matches a three-dimensional shape of a centerline surface of the plate-like body of said main plate-like element.

2. The method as claimed in claim 1, comprising:
making a first semifinished metal part having a three-dimensional shape that over-approximates a shape of the coupling root of the blade, and including a projecting appendage having a three-dimensional shape that over-approximates a shape of the lower connecting fin;
shaping a lower edge of the blank plate and a ridge of the projecting appendage of the first semifinished metal part, so that the lower edge of the blank plate and the ridge of the projecting appendage of the first semifinished metal part are complementary in shape;
placing the lower edge of the blank plate on the ridge of the projecting appendage of the first semifinished metal part, so that blank plate is aligned locally with the projecting appendage; and
butt-welding the lower edge of the blank plate to the ridge of the projecting appendage of the first semifinished metal part to connect the blank plate and the projecting appendage of the first semifinished metal part rigidly to each other.

3. The method as claimed in claim 2, wherein the lower edge of the blank plate and the ridge of the projecting appendage of the first semifinished metal part are shaped to extend from a leading edge to a trailing edge of the airfoil-shaped oblong member along a curved, substantially Ω (omega) shaped path.

4. The method as claimed in claim 1, wherein a thickness of said flat plate over-approximates the maximum thickness of the plate-like body of the blade.

5. The method as claimed in claim 1, wherein said blade also comprises an upper coupling head; the main plate-like element also comprises an upper connecting fin cantilevered from the coupling head towards the coupling root and connected to said plate-like body; and the method also comprises:
making a second semifinished metal part having a three-dimensional shape that over-approximates a shape of the upper coupling head of the blade, and including a projecting appendage having a three-dimensional shape that over-approximates a shape of the upper connecting fin;
shaping an upper edge of the blank plate and a ridge of the projecting appendage of the second semifinished metal part, so that the upper edge of the blank plate and the ridge of the projecting appendage of the second semifinished metal part are complementary in shape;
placing the upper edge of the blank plate on the ridge of the projecting appendage of the second semifinished metal part, so that the blank plate is aligned locally with the projecting appendage of the second semifinished metal part; and
butt-welding the upper edge of the blank plate to the ridge of the projecting appendage of the second semifinished metal part to connect the blank plate and the projecting appendage of the second semifinished metal part rigidly to each other and thereby form a resulting part.

6. The method as claimed in claim 5, wherein the upper edge of the blank plate and the ridge of the projecting appendage of the second semifinished metal part are shaped to extend from a leading edge to the trailing edge of the airfoil-shaped oblong member along a curved, substantially Ω (omega) shaped path.

7. The method as claimed in claim 1, comprising, after the blank plate is welded to the first semifinished metal part to produce the resulting part, trimming/machining excess material off the resulting part to obtain the coupling root, and the main plate-like element.

8. The method as claimed in claim 7, wherein trimming/machining excess material off the resulting part comprises trimming/machining excess material off the first semifinished metal part, to obtain the coupling root.

9. The method as claimed in claim 7, wherein trimming/machining excess material off the resulting part comprises trimming/machining excess material off long side edges of the blank plate, and the projecting appendage of the first semifinished metal part, so as to form a leading edge and a trailing edge of the airfoil-shaped oblong member.

10. The method as claimed in claim 7, wherein trimming/machining excess material off the resulting part comprises trimming/machining excess material off of two major faces of the blank plate, and two major faces of the projecting appendage of the first semifinished part, so as to obtain the main plate-like element of the airfoil-shaped oblong member.

11. The method as claimed in claim 1, wherein said hollow weight-reducing seat extends over more than 40% of a total area of the face of the main plate-like element in which the hollow weight-reducing seat is formed.

12. The method as claimed in claim 1, wherein trimming/machining excess material off the resulting part comprises trimming/machining excess metal off of two major faces of the blank plate, and two major faces of the projecting appendage of the first semifinished part, so as to obtain the main plate-like element of the airfoil-shaped oblong member, together with the hollow weight-reducing seat.

13. The method as claimed in claim 12, comprising, after forming the hollow weight-reducing seat in one of the two faces of the main plate-like element, closing an opening of the hollow weight-reducing seat by a second plate-like element of predetermined thickness, so as to complete an outer profile of the airfoil-shaped oblong member.

14. The method as claimed in claim 13, wherein closing the opening of the hollow weight-reducing seat in the main plate-like element comprises:
making the second plate-like element, which has a three-dimensional shape that is complementary to a shape of the opening of the hollow weight-reducing seat in the main plate-like element, and the thickness of the second plate-like element is less than a depth of the hollow weight-reducing seat;
placing the second plate-like element on the face of the main plate-like element in which the hollow weight-reducing seat is formed, so as to close the opening of the hollow weight-reducing seat; and
fixing the second plate-like element irremovably to said main plate-like element.

15. The method as claimed in claim 1, wherein the blank plate is obtained by press-forming said flat metal plate.
